(19) United States
(12) Patent Application Publication
(10) Pub. No.: US 2016/0177141 A1
(43) Pub. Date: Jun. 23, 2016

(54) Hot Melt Pressure-Sensitive Adhesives for Removable Applications

(71) Applicant: ExxonMobil Chemical Patents Inc., Baytown, TX (US)

(72) Inventors: Jurgen J. M. Schroeyers, Helchteren (BE); Eddy Swiggers, Kapelle-op-den-Bos (BE); James N. Coffey, League City, TX (US); Jennifer J. Austin, The Woodlands, TX (US)

(21) Appl. No.: 14/924,367

(22) Filed: Oct. 27, 2015

Related U.S. Application Data
(60) Provisional application No. 62/093,921, filed on Dec. 18, 2014.

(51) Int. Cl. C09J 123/14; C09J 7/02

(52) U.S. Cl. CPC C09J 123/142; C09J 7/0221; C09J 2423/10

(57) ABSTRACT

The present invention is related to pressure-sensitive hot melt adhesive compositions and their applications. In particular, the adhesive compositions described herein comprise a block copolymer component, a hydrocarbon tackifier resin component, and a propylene-based polymer component, wherein the propylene-based polymer component has a MFR of greater than about 1,000 g/10 min to less than about 10,000 g/10 min.

### CROSS-REFERENCE TO RELATED APPLICATIONS

This application claims priority to and the benefit of U.S. Provisional Application Ser. No. 62/093,921, filed Dec. 18, 2014, which is incorporated herein by reference.

### FIELD OF THE INVENTION

The present invention is related to pressure-sensitive hot melt adhesive compositions and their applications. In particular, the adhesive compositions described herein comprise a block copolymer component, a hydrocarbon tackifier resin component, and a propylene-based polymer component.

### BACKGROUND OF THE INVENTION

Pressure-sensitive adhesives are well known, and are used in a wide variety of label and tape applications. Such adhesives may be applied to, for example, paper, plastic films, metal, etc. to form the aforementioned labels or tapes. These labels and tapes may be affixed to a wide variety of substrates, and in many cases are removable or repositionable.

Pressure-sensitive hot melt adhesive systems are known in the art and consist of tackified thermoplastic elastomers such as styrenic block copolymers together with tackifying resin(s) and generally some plasticizing oil, an antioxidant and optionally fillers. Styrenic block copolymers containing polystyrene and polybutadiene blocks and/or polyisoprene blocks are particularly useful. These materials are generally available as pure triblocks, (sometimes referred to as SIS and SBS copolymers), and diblocks (sometimes referred to as SI and SB copolymers or SIB copolymers). The materials are also available as mixtures of diblock and triblock materials (sometimes referred to as SIS+SI and SIS+SB).

It is known to use diblock/triblock blends as the elastomeric component in hot-melt pressure-sensitive adhesives. It is further known that adhesive properties and viscosity can be controlled by varying the diblock-to-triblock ratio, varying the styrene content, varying the polymer molecular weight, and varying the block molecular weights within the polymers. The melt viscosity can also be controlled by the addition of plasticizing oils and varying the molecular weight of the polymers.

One drawback of such adhesive formulations is that, in order to achieve the desired processability and removability of a product, many additives such as silicone oils, waxes, and other fillers must be added. Incorporation of such additives leads to increased expense, and also limits the equipment that may be used to manufacture the adhesive compositions.

U.S. Pat. No. 5,523,343 discloses a pressure sensitive hot melt adhesive composition comprising a blend of a radial SB copolymer and a SIS block copolymer. The composition also includes a tackifier resin and plasticizer oils.

U.S. Pat. No. 6,384,138 discloses a hot melt pressure sensitive adhesive composition for use with oriented polypropylene films which comprises a blend of styrene-isoprene-styrene (SIS) and styrene-butadiene-styrene (SBS) block copolymers combined with a blend of hydrocarbon resins.

U.S. Publication No. 2009/0133834 discloses radial block copolymer compositions and pressure-sensitive adhesive compositions based thereon.

U.S. Publication No. 2011/0104487 discloses an adhesive composition comprising a propylene-based polymer component, block copolymer component, a tackifier. However, the low melt flow rate/high viscosity of such propylene-based polymer components disclosed in that application limits the amount of polymer loaded in the adhesive composition and therefore requires the inclusion of costly additives.

It would be useful, therefore, to develop an adhesive composition for use with labels and/or tapes having the properties of a typical block copolymer-based adhesive at a lower cost and with increased processability. The invention described herein accomplishes this by blending a block copolymer component with a hydrocarbon tackifier resin component and a propylene-based polymer component, where the propylene-based polymer component is a high melt flow rate polymer.

### SUMMARY OF THE INVENTION

The present invention is directed to pressure-sensitive hot melt adhesive compositions and their commercial applications. In one or more embodiments, the adhesive compositions comprise at least one block copolymer component, at least one hydrocarbon tackifier resin component, and at least one propylene-based polymer component, wherein the propylene-based polymer component comprises a first propylene-based polymer, wherein the first propylene-based polymer is a homopolymer of propylene or a copolymer of propylene and ethylene or a C₄ to C₁₀ alpha-olefin, and a second propylene-based polymer, wherein the second propylene-based polymer is a homopolymer of propylene or a copolymer of propylene and ethylene or a C₄ to C₁₀ alpha-olefin, wherein the second propylene-based polymer is different than the first propylene-based polymer and wherein the propylene-based polymer component has a MFR of greater than about 1,000 g/10 min to less than about 10,000 g/10 min.

In one or more embodiments, the present invention is also related to an adhesive article comprising: a substrate; and a pressure-sensitive hot melt adhesive composition comprising: at least one block copolymer component; at least one hydrocarbon resin tackifier component; and at least one propylene-based polymer component, wherein the propylene-based polymer component comprises a first propylene-based polymer, wherein the first propylene-based polymer is a homopolymer of propylene or a copolymer of propylene and ethylene or a C₄ to C₁₀ alpha-olefin and a second propylene-based polymer wherein the second propylene-based polymer is a homopolymer of propylene or a copolymer of propylene and ethylene or a C₄ to C₁₀ alpha-olefin, wherein the second propylene-based polymer is different than the first propylene-based polymer and wherein the propylene-based polymer component has a MFR of greater than about 1,000 g/10 min to less than about 10,000 g/10 min.

### DETAILED DESCRIPTION OF THE INVENTION

The pressure-sensitive hot melt adhesive compositions of the present invention comprise a block copolymer component, a hydrocarbon tackifier resin component, and a propylene-based polymer component. In one or more embodiments, the adhesive compositions may also comprise a process oil component. Further embodiments of the adhesive compositions described herein and their individual components are described in greater detail below.

As used herein, the term “copolymer” is meant to include polymers having two or more monomers, optionally with other monomers, and may refer to interpolymers, terpolymers, etc. The term “polymer” as used herein includes homopolymers and copolymers.

### Block Copolymer Component

The adhesive compositions described herein comprise a block copolymer component such as a styrenic block copolymer. The phrase “block copolymer” is intended to include any manner of block copolymer having two or more polymer chains attached at their ends, including but not limited to diblock, triblock, and tetrablock copolymers. “Block copolymer” is further meant to include copolymers having any structure known to those of skill in the art, including but not limited to linear, radial or multi-arm star, multi-branched block copolymers, and random block copolymers. “Linear block copolymers” comprise two or more polymer chains in sequence. “Radial block copolymers” (or “star block copolymers”) comprise more than two linear block copolymers attached at a common branch point. “Styrenic block copolymers” comprise a block copolymer having at least one block that is substantially styrene. While the block copolymers may be linear or radial, combinations of linear and radial block copolymers are particularly useful. The block copolymers may or may not be hydrogenated.

A linear diblock copolymer would traditionally have the formula (A-B) wherein A is substantially a vinyl aromatic block and B is substantially a polydiene block. The polydiene in the B block may be a conjugated diene block or the B block may be a combination of conjugated dienes such as polyisoprene and polybutadiene either in block or random order.

A linear diblock (A-B) may also include a random block copolymer wherein the B block may include styrene randomly inserted into the B block in addition to the one or more dienes. Examples of such random block copolymers having styrene included in the B block include Solprene™ 1205 (a linear random-block styrene-butadiene copolymer having a 25% bound styrene content, 17.5% present as a polystyrene block, and a specific gravity of 0.93) available from Dynasol Elastomeros S.A. de C.V. of Mexico.

The vinyl aromatic block may be derived from styrene, alpha-methylstyrene, p-methylstyrene, o-methylstyrene, p-tert-butylstyrene, 2,4-dimethylstyrene, diphenylethylenes including stilbene, vinyl naphthalene, vinyltoluene (a mixture of meta- and para-isomers of methylstyrene), vinylxylene and combinations thereof. Of these vinyl aromatic monomers, styrene is preferred, although the vinyl aromatic block may comprise styrene and less than 5 wt % of the other vinyl aromatic monomers previously mentioned.

A linear styrene-diene-styrene triblock copolymer would traditionally have the formula (A-B-A) wherein A is substantially a vinyl aromatic block and B is substantially a polydiene block. The polydiene in the B block may be a conjugated diene block or the B block may be a combination of conjugated dienes such as polyisoprene and polybutadiene either in block or random order. In another embodiment, the B block may also include styrene randomly inserted into the B block in addition to the one or more dienes to form a random block copolymer.

Suitable block copolymers include linear block copolymers of styrene and one or more conjugated dienes such as SI (styrene-isoprene), SIS (styrene-isoprene-styrene), SB (styrene-butadiene), SBS (styrene-butadiene-styrene), SIB (styrene-isoprene-butadiene), or combination thereof.

Block copolymers comprising tetrablock or pentablock copolymers selected from A-B-A-B tetrablock copolymers or A-B-A-B-A pentablock copolymers and the like are also suitable such as SISI (styrene-isoprene-styrene-isoprene), SISB, SBSB, SBSI, SIBS, ISISI, ISISB, BSISB, ISBSI, BSBSB, and BSBSI block copolymers.

In one or more embodiments, the linear block copolymer includes a linear polymer of the formula S-I-S or S-B-S wherein S is substantially a polystyrene block, I is substantially a polyisoprene block, and B is substantially a polybutadiene block. The styrene content of the SBS block copolymer is typically from about 10 to about 45 wt %, or from about 15 to about 35 wt %, or from about 20 to 30 wt %. The SIS block copolymers may be prepared by well known anionic solution polymerization techniques using lithium-type initiators such as disclosed in U.S. Pat. Nos. 3,251,905 and 3,239,478, which are hereby incorporated by reference in their entireties. The SIS and the SBS copolymer may be a pure triblock (one having less than 0.1 wt % of diblock polymer, preferably 0% diblock polymer), or may contain from about 0.1 to about 85 wt %, or from about 0.1 to about 75 wt %, or from about 1 to about 65 wt %, or from about 5 to about 50 wt %, or from 5 to 25 wt %, or from 10 to 20 wt % diblock copolymer having the structure S-I or SB, respectively. The SI or SB diblock may be present as a residue from the manufacture of the triblock copolymer or may be separately blended with the triblock as a further technique for achieving target polystyrene content or modifying the cohesive properties of the composition. In one or more embodiments, the number average molecular weight of the diblock SI copolymers may range from about 100,000 to about 250,000.

The SBS or SIS linear block copolymers employed herein may have a number average molecular weight (Mn) (determined by GPC) in the range of from about 50,000 to 500,000, or from about 100,000 to about 180,000, or from about 110,000 to about 160,000, or from about 110,000 to about 140,000.

Linear SBS and SIS block copolymers of the type described herein are available commercially and are prepared in accordance with methods known in the art. Examples of SBS and SIS copolymers useful in the practice of this invention include those available under the trade names Vector (from Dexco Polymers LLP), Kraton (from Kraton Polymers LLC), Europrene (from Polimeri), and Finaprene (from Total PetroChemicals). Particularly useful triblock copolymers include, but are not limited to, Vector™ 4111A, 4113A, 4114A, 4211A, 4215A, 4411A, 2518A, 2518P, 4461, 6241, 7400, and 8508A; Kraton D 1102, D 4141, D 4158, Europrene SOL T 166, and Finaprene 411. In one or more embodiments, the SIS block copolymers used in this invention may have a melt flow rate in the range of from about 5 to 40 g/10 min., as measured by ASTM D 1238 using condition G (200° C., 5 kg weight).

In one or more embodiments, the block copolymer component may be a radial block copolymer. A radial block copolymer would traditionally have the notation (A-B)ₙX wherein A is substantially a vinyl aromatic block such as styrene, B is substantially a polydiene block, X is the residue of a multifunctional coupling agent used in the production of the radial block copolymer, and n is an integer of from about 2 to about 10, from 3 to 8, from 3 to 7, from 4 to 6, or 4. In the same or other embodiments, the radial block copolymer component may have a linear block copolymer content of from about 0 to about 85 wt % such as a diblock copolymer. Linear block content may be determined by GPC, and may be manipulated via the reactor settings employed to produce the block copolymer component. Linear block content may also be adjusted after production by blending an additional quantity of linear block material into the block copolymer component. Linear block content in the radial block copolymer may be from 5 to 90 wt %, 15 to about 90 wt %, or from about 20 to about 85 wt %, or from about 25 to about 80 wt %.

The production of radial block copolymers often results in an amount of block copolymer which is linear in structure, along with the radial structure. Also, a linear block copolymer may be added to the radial block copolymer to modify the properties of the block copolymer. These block copolymers may be referred to in terms of their linear block content such as a diblock content, wherein the linear block content (expressed as a percentage) refers to the amount of copolymer which is linear in structure. The remaining portion of the block copolymer not included in the linear block percentage is therefore radial in structure. Accordingly, the radial block copolymer (A-B)ₙ will typically comprise a linear component (A-B) wherein A is substantially a vinyl aromatic block and B is substantially a polydiene block. A typical notation for such a radial/linear combination is (A-B)ₙ/A-B. The vinyl aromatic content (e.g. styrene) of the (A-B)ₙ block copolymer or the (A-B)ₙ/A-B block copolymer composition is typically from about 10 to about 45 wt %, or from about 15 to about 35 wt %, or from about 17 to 22 wt %.

Suitable block copolymer compositions comprising radial and linear block copolymers such as (SI)ₙ/(SI) may have a diblock content of from about 15 to about 90 wt %, or from about 20 to about 85 wt %, or from about 25 to about 80 wt %. Other suitable block copolymers include (SB)ₙ/(SB) which may have a diblock content of from about 5 to about 90 wt %, or from about 5 to about 50 wt %, or from about 5 to about 25 wt %, or from about 5 to about 15 wt %.

These radial block copolymers are multi-armed, and may have, for example, three, four, five, or more arms extending from a central point in a radial fashion, wherein one end of each arm is connected to the other arms at the center of the copolymer structure via a coupling agent or coupling group. Coupling agents are well known in the art, and any suitable multifunctional coupling agent may be used to form the radial block copolymers described herein. Suitable coupling agents may include, for example, silanes, liquid and metallic multifunctional acrylates and methacrylates, functionalized polybutadiene resins, functionalized cyanurate, allyl isocyanurate, and diesters.

In some embodiments, the radial block copolymer component is a styrenic block copolymer chosen from a styrene-isoprene (SI)ₙ block copolymer or a styrene-butadiene (SB)ₙ block copolymer. In other embodiments, the radial block copolymer may comprise a mixture of a radial and linear block copolymer such as (SI)ₙ/(SI) or (SB)ₙ/(SB).

The radial (A-B)ₙ or (A-B)ₙ/A-B block copolymers employed herein may have a number average molecular weight (Mn) (determined by GPC) in the range of from about 50,000 to 500,000, or from about 70,000 to about 250,000, or from about 90,000 to about 175,000, or from about 90,000 to about 135,000. Specifically, radial SI or SB copolymers useful in the practice of the invention may have a molecular weight (Mn) of from about 180,000 to about 250,000.

The radial block copolymers or radial and linear block copolymer compositions useful for the present invention may additionally have a melt flow rate (MFR) (200° C., 5 kg) from about 5 to about 35 g/10 min, or from about 10 to about 30 g/10 min, or from about 12 to about 25 g/10 min. Further, the copolymers may have a specific gravity from about 0.90 to about 0.97, or from about 0.92 to about 0.95; a molecular weight (Mn) from about 125,000 to about 300,000, or from about 150,000 to about 275,000, or from about 175,000 to about 250,000; and/or a Shore A hardness (ASTM D 2240) from about 35 to about 55, or from about 40 to about 50. Suitable radial block copolymer compositions with linear block copolymer such as (SI)ₙ/(SI) include, but are not limited to, those available under the trade names Vector 4230 and Vector 4186A from Dexco Polymers LLP. Suitable radial block copolymer compositions with linear block copolymer such as (SB)ₙ/(SB) include, but are not limited to, those available under the trade names Vector 2411 and 2411P from Dexco Polymers LLP.

In other embodiments, radial styrenic triblock copolymers and other styrenic block copolymers suitable for use in the present invention include those described in U.S. Application Pub. No. 2009/0133834, which is incorporated by reference herein in its entirety.

The radial or linear A-B block copolymers may comprise a blend of two or more different A-B copolymers, which may have the same or different styrene content, and may be blended to a ratio in the range of from 10:1 to 1:10 parts by weight. The use of two different A-B block copolymers may offer improved cohesive strength and allow more precise tailoring of the polystyrene content.

In another embodiment, the B block (diene block) may be hydrogenated. For example, hydrogenating the B block (diene block) of an A-B diblock or an A-B-A triblock may produce a B block comprising at least one olefin wherein the olefin is chosen from ethylene, propylene, and butylene. Suitable block copolymers are the Kraton™ G Series polymers including SEP (styrene-ethylene-propylene), SEBS (styrene-ethylene-butylene-styrene) and SEPS (styrene-ethylene-propylene-styrene). Examples of the Kraton™ G series that are commercially available include Kraton™ G1702H (diblock) and Kraton™ A1535H (triblock).

In one or more embodiments, the pressure-sensitive hot melt adhesive compositions described herein may comprise from about 25 to about 65 wt %, or from about 30 to about 60 wt % or from about 35 to about 55 wt % of the block copolymer component.

### Hydrocarbon Tackifier Component

In one or more embodiments of the present invention, the adhesive compositions described herein comprise a hydrocarbon tackifier resin component, which may in turn comprise one or more hydrocarbon tackifier resins.

Hydrocarbon tackifier resins suitable for use in the present invention include, but are not limited to, aliphatic hydrocarbon resins, at least partially hydrogenated aliphatic hydrocarbon resins, aliphatic/aromatic hydrocarbon resins, at least partially hydrogenated aliphatic aromatic hydrocarbon resins, aromatic resins, at least partially hydrogenated aromatic hydrocarbon resins, cycloaliphatic hydrocarbon resins, at least partially hydrogenated cycloaliphatic resins, cycloaliphatic/aromatic hydrocarbon resins, cycloaliphatic/aromatic at least partially hydrogenated hydrocarbon resins, polyterpene resins, terpene-phenol resins, rosin esters, rosin acids, grafted resins, and mixtures of two or more of the foregoing. The hydrocarbon tackifiers may be polar or apolar.

In one embodiment, the tackifier component may comprise one or more hydrocarbon resins produced by the thermal polymerization of cyclopentadiene (CPD) or substituted CPD, which may further include aliphatic or aromatic monomers as described later. The hydrocarbon resin may be a non-aromatic resin or an aromatic resin. The hydrocarbon resin may have an aromatic content between 0% and 60%, preferably between 1% and 60%, or between 1% and 40%, or between 1% and 20%, or between 10% and 20%. In further embodiments, the hydrocarbon resin may have an aromatic content between 15% and 20%, or between 1% and 10%, or between 5% and 10%.

In another embodiment, the tackifier component may comprise hydrocarbon resins produced by the catalytic (cationic) polymerization of linear dienes. Such monomers are primarily derived from Steam Cracked Naptha (SCN) and include C₅ dienes such as piperylene (also known as 1,3-pentadiene). Polymerizable aromatic monomers can also be used to produce resins and may be relatively pure, e.g. styrene, -methyl styrene, or from a C₉-aromatic SCN stream. Such aromatic monomers can be used alone or in combination with the linear dienes previously described. “Natural” monomers can also be used to produce resins, e.g., terpenes such as α-pinene or β-carene, either used alone or in high or low concentrations with other polymerizable monomers. Typical catalysts used to make these resins are AlCl₃ and BF₃, either alone or complexed. Mono-olefin modifiers such as 2-methyl, 2-butene may also be used to control the molecular weight distribution (MWD) of the final resin. The final resin may be partially or totally hydrogenated as described in further detail below.

As used herein, aromatic content and olefin content are measured by ¹H-NMR, as measured directly from the ¹H NMR spectrum from a spectrometer with a field strength greater than 300 MHz, preferably 400 MHz. Aromatic content is the integration of aromatic protons versus the total number of protons. Olefin proton or olefinic proton content is the integration of olefinic protons versus the total number of protons.

In one or more embodiments, the resin may be at least partially hydrogenated or substantially hydrogenated. As used herein, “at least partially hydrogenated” means that the material contains less than 90% olefinic protons, or less than 75% olefinic protons, or less than 50% olefinic protons, or less than 40% olefinic protons, or less than 25% olefinic protons. As used herein, “substantially hydrogenated” means that the material contains less than 5% olefinic protons, or less than 4% olefinic protons, or less than 3% olefinic protons, or less than 2% olefinic protons. The degree of hydrogenation is typically conducted so as to minimize and preferably avoid hydrogenation of the aromatic bonds.

In one or more embodiments, hydrocarbon tackifier resins described herein may be uniquely characterized as totally or substantially amorphous in nature. This means that a glass transition temperature (T_{g}) is detectable, e.g., by Differential Scanning calorimetry (DSC) but they have no melting point (Tₘ). To characterize these resins, it is generally accepted to use a test that roughly correlates with T_{g}, such as softening point (SP), which provides approximate, but not exact, values. The softening point (SP) of the resins is measured by a ring-and-ball softening point test according to ASTM E-28.

In some embodiments, the hydrocarbon resin may have a softening point of from about 50° C. to about 140° C., or from about 60° C. to about 130° C., or from about 70° C. to about 120° C., or from about 80° C. to about 110° C.

Typically, in one or more embodiments of the invention, the hydrocarbon resin has a number average molecular weight (Mn) from about 400 to about 3000, a weight average molecular weight (Mw) from about 500 to about 6000, a z-average molecular weight (Mz) from about 700 to about 15,000 and a polydispersity (PD), defined as Mw/Mn, between about 1.5 and about 4. As used herein, molecular weights (number average molecular weight (Mn), weight average molecular weight (Mw), and z-average molecular weight (Mz)) are measured by size exclusion chromatography using a Waters 150 Gel Permeation Chromatograph equipped with a differential refractive index detector and calibrated using polystyrene standards. Samples are run in tetrahydrofuran (THF) (45° C.). Molecular weights are reported as polystyrene-equivalent molecular weights and are generally measured in g/mol.

In one or more embodiments of the invention, the hydrocarbon tackifier resin component may comprise one or more oligomers such as dimers, trimers, tetramers, pentamers, and hexamers. The oligomers may be derived from a petroleum distillate boiling in the range of 30-210° C. The oligomers may be derived from any suitable process and are often derived as a byproduct of resin polymerization. Suitable oligomer streams may have molecular weights (Mn) between 130-500, more preferably between 130-410, more preferably between 130 and 350, or between 130 and 270, or between 200 and 350, or between 200 and 320. Examples of suitable oligomer streams include, but are not limited to, oligomers of cyclopentadiene and substituted cyclopentadiene, oligomers of C₄-C₆ conjugated diolefins, oligomers of C₈-C₁₀ aromatic olefins, and combinations thereof. Other monomers may be present. These include C₄-C₆ mono-olefins and terpenes. The oligomers may comprise one or more aromatic monomers and may be at least partially hydrogenated or substantially hydrogenated.

In one embodiment, the oligomers may be stripped from the resin before hydrogenation. The oligomers may also be hydrogenated with the resin and then stripped from the resin, yielding a hydrogenated resin and hydrogenated oligomers. In another embodiment, at least some of the oligomers are stripped before hydrogenation and at least some hydrogenated oligomers are stripped after hydrogenation. In yet another embodiment, the hydrogenated resin/oligomers product may be further processed together as a single mixture as described below. In yet another embodiment, the oligomers can be derived from any suitable source and hydrogenated (if necessary) before grafting so that the oligomers before grafting are typically at least partially hydrogenated and preferably substantially hydrogenated.

The hydrocarbon tackifier resin component may comprise one or more hydrocarbon tackifier resins. These resins may be chosen based upon their compatibility with the one or more block copolymers which comprise the block copolymer component of the adhesive composition. For example, certain tackifier resins may be better suited for use with SIS block copolymers, while other tackifier resins may be more compatible with SBS block copolymers.

Examples of commercially available SIS compatible tackifier resins include, but are not limited to, Escorez 2203LC, Escorez 1310LC, Escorez 1304, Escorez 5380, and Escorez 5600, manufactured by ExxonMobil Chemical Company; Piccotac 1905 and Eastotac H-100, manufactured by Eastman Chemicals; Quintone D and Quintone U 185, manufactured by Nippon Zeon; Marukares R100, manufactured by Maruzen; and Wingtack Extra and Wingtack Plus, manufactured by Cray Valley.

Examples of commercially available SBS compatible tackifier resins include, but are not limited to, Escorez 2101, Escorez 5690, and Escorez 2173, manufactured by ExxonMobil Chemical Company; Regalrez 5095, Regalrez 3102, Staybelite Ester 3, and Pentalyn H, manufactured by Eastman Chemicals; Quintone U 190, manufactured by Nippon Zeon; Wingtack 86, manufactured by Cray Valley; and Sylvalite RE 885 and Sylvatac RE 85, available from Arizona Chemical.

In one or more embodiments, the pressure-sensitive hot melt adhesive compositions described herein may comprise from about 5 to about 50 wt %, or from about 10 to about 40 wt %, or from about 15 to about 35 wt % of the hydrocarbon tackifier resin component.

### Propylene-Based Polymer Component

The Propylene-based polymer component (“PBP”) useful in the invention comprises a first predominantly propylene-based polymer, wherein the first predominantly propylene-based polymer is a homopolymer of propylene or a copolymer of propylene and ethylene or a C₄ to C₁₀ alpha-olefin; and a second predominantly propylene-based polymer, wherein the second predominantly propylene-based polymer is a homopolymer of propylene or comprises a comonomer of ethylene or a C₄ to C₁₀ alpha-olefin; wherein the second predominantly propylene-based polymer is compositionally different than the first predominantly propylene-based polymer.

### Methods of Preparing PBPs

A solution polymerization process for preparing a PBP is generally performed by a system that includes a first reactor, a second reactor in parallel with the first reactor, a liquid-phase separator, a devolatilizing vessel, and a pelletizer. The first reactor and second reactor may be, for example, continuously stirred-tank reactors.

The first reactor may receive a first monomer feed, a second monomer feed, and a catalyst feed. The first reactor may also receive feeds of a solvent and an activator. The solvent and/or the activator feed may be combined with any of the first monomer feed, the second monomer feed, or catalyst feed or the solvent and activator may be supplied to the reactor in separate feed streams. A first polymer is produced in the first reactor and is evacuated from the first reactor via a first product stream. The first product stream comprises the first polymer, solvent, and any unreacted monomer.

In any embodiment, the first monomer in the first monomer feed may be propylene and the second monomer in the second monomer feed may be ethylene or a C₄ to C₁₀ olefin. In any embodiment, the second monomer may be ethylene, butene, hexene, and octene. Generally, the choice of monomers and relative amounts of chosen monomers employed in the process depends on the desired properties of the first polymer and final PBP. In any embodiment, the relative amounts of propylene and comonomer supplied to the first reactor may be designed to produce a polymer that is predominantly propylene, i.e., a polymer that is more than 50 mol % propylene. In another embodiment, the first reactor may produce a homopolymer of propylene.

Preferably, the second polymer is different than the first polymer. The difference may be measured, for example, by the comonomer content, heat of fusion, crystallinity, branching index, weight average molecular weight, and/or polydispersity of the two polymers. In any embodiment, the second polymer may comprise a different comonomer than the first polymer or one polymer may be a homopolymer of propylene and the other polymer may comprise a copolymer of propylene and ethylene or a C₄ to C₁₀ olefin. For example, the first polymer may comprise a propylene-ethylene copolymer and the second polymer may comprise a propylene-hexene copolymer. In any embodiment, the second polymer may have a different weight average molecular weight (Mw) than the first polymer and/or a different melt viscosity than the first polymer. Furthermore, in any embodiment, the second polymer may have a different crystallinity and/or heat of fusion than the first polymer.

It should be appreciated that any number of additional reactors may be employed to produce other polymers that may be integrated with (e.g., grafted) or blended with the first and second polymers. Further description of exemplary methods for polymerizing the polymers described herein may be found in U.S. Pat. No. 6,881,800, which is incorporated by reference herein.

The first product stream and second product stream may be combined to produce a blend stream. For example, the first product stream and second product stream may supply the first and second polymer to a mixing vessel, such as a mixing tank with an agitator.

The blend stream may be fed to a liquid-phase separation vessel to produce a polymer rich phase and a polymer lean phase. The polymer lean phase may comprise the solvent and be substantially free of polymer. At least a portion of the polymer lean phase may be evacuated from the liquid-phase separation vessel via a solvent recirculation stream. The solvent recirculation stream may further include unreacted monomer. At least a portion of the polymer rich phase may be evacuated from the liquid-phase separation vessel via a polymer rich stream.

In any embodiment, the liquid-phase separation vessel may operate on the principle of Lower Critical Solution Temperature (LCST) phase separation. This technique uses the thermodynamic principle of spinodal decomposition to generate two liquid phases; one substantially free of polymer and the other containing the dissolved polymer at a higher concentration than the single liquid feed to the liquid-phase separation vessel.

Employing a liquid-phase separation vessel that utilizes spinodal decomposition to achieve the formation of two liquid phases may be an effective method for separating solvent from multi-modal polymer PBPs, particularly in cases in which one of the polymers of the PBP has a weight average molecular weight less than 100,000 g/mol, and even more particularly between 10,000 g/mol and 60,000 g/mol. The concentration of polymer in the polymer lean phase may be further reduced by catalyst selection. Catalysts of Formula I (described below), particularly dimethylsilyl bis(2-methyl-4-phenylindenyl)zirconium dichloride, dimethylsilyl bis(2-methyl-5-phenylindenyl)hafnium dichloride, dimethylsilyl bis(2-methyl-4-phenylindenyl)zirconium dimethyl, and dimethylsilyl bis(2-methyl-4-phenylindenyl)hafnium dimethyl were found to be a particularly effective catalysts for minimizing the concentration of polymer in the lean phase. Accordingly, in any embodiment, one, both, or all polymers may be produced using a catalyst of Formula I, particularly dimethylsilyl bis(2-methyl-4-phenylindenyl)zirconium dichloride, dimethylsilyl bis(2-methyl-4-phenylindenyl)hafnium dichloride, dimethylsilyl bis(2-methyl-4-phenylindenyl)zirconium dimethyl, and dimethylsilyl bis(2-methyl-4-phenylindenyl)hafnium dimethyl.

Upon exiting the liquid-phase separation vessel, the polymer rich stream may then be fed to a devolatilizing vessel for further polymer recovery. In any embodiment, the polymer rich stream may also be fed to a low pressure separator before being fed to the inlet of the devolatilizing vessel. While in the vessel, the polymer composition may be subjected to a vacuum in the vessel such that at least a portion of the solvent is removed from the polymer composition and the temperature of the polymer composition is reduced, thereby forming a second polymer composition comprising the PBP and having a lower solvent content and a lower temperature than the polymer composition as the polymer composition is introduced into the vessel. The polymer composition may then be discharged from the outlet of the vessel via a discharge stream.

The cooled discharge stream may then be fed to a pelletizer where the PBP is then discharged through a pelletization die as formed pellets. Pelletization of the polymer may be by an underwater, hot face, strand, water ring, or other similar pelletizer. Preferably an underwater pelletizer is used, but other equivalent pelletizing units known to those skilled in the art may also be used. General techniques for underwater pelletizing are known to those of ordinary skill in the art.

International Publication No. 2013/134038 generally describes the method of preparing PBPs. The contents of International Publication No. 2013/134038 and its parent application U.S. Patent Application Ser. No. 61/609,020 filed Mar. 9, 2012, are both incorporated herein in their entirety.

### Polymers of the PBPs

Preferred polymers of the PBP are semi-crystalline propylene-based polymers. In any embodiment, the polymers may have a relatively low molecular weight, preferably about 150,000 g/mol or less. In any embodiment, the polymer may comprise a comonomer selected from the group consisting of ethylene and linear or branched C₄ to C₂₀ olefins and diolefins. In any embodiment, the comonomer may be ethylene or a C₄ to C₁₀ olefin.

In any embodiment, one or more polymers of the PBP may comprise one or more propylene-based polymers, which comprise propylene and from about 5 mol % to about 30 mol % of one or more comonomers selected from C₂ and C₄-C₁₀ α-olefins. In any embodiment, the α-olefin comonomer units may derive from ethylene, butene, pentene, hexene, 4-methyl-1-pentene, octene, or decene. The embodiments described below are discussed with reference to ethylene and hexene as the α-olefin comonomer, but the embodiments are equally applicable to other copolymers with other α-olefin comonomers. In this regard, the copolymers may simply be referred to as propylene-based polymers with reference to ethylene or hexene as the α-olefin.

In any embodiment, the one or more polymers of the PBP may include at least about 5 mol %, at least about 6 mol %, at least about 7 mol %, or at least about 8 mol %, or at least about 10 mol %, or at least about 12 mol % ethylene-derived or hexene-derived units. In those or other embodiments, the copolymers may include up to about 30 mol %, or up to about 25 mol %, or up to about 22 mol %, or up to about 20 mol %, or up to about 19 mol %, or up to about 18 mol %, or up to about 17 mol % ethylene-derived or hexene-derived units, where the percentage by mole is based upon the total moles of the propylene-derived and α-olefin derived units. Stated another way, the propylene-based polymer may include at least about 70 mol %, or at least about 75 mol %, or at least about 80 mol %, or at least about 81 mol % propylene-derived units, or at least about 82 mol % propylene-derived units, or at least about 83 mol % propylene-derived units; and in these or other embodiments, the copolymers may include up to about 95 mol %, or up to about 94 mol %, or up to about 93 mol %, or up to about 92 mol %, or up to about 90 mol %, or up to about 88 mol % propylene-derived units, where the percentage by mole is based upon the total moles of the propylene-derived and alpha-olefin derived units. In any embodiment, the propylene-based polymer may comprise from about 5 mol % to about 25 mol % ethylene-derived or hexene-derived units, or from about 8 mol % to about 20 mol % ethylene-derived or hexene-derived units, or from about 12 mol % to about 18 mol % ethylene-derived or hexene-derived units.

The one or more polymers of the PBP of one or more embodiments are characterized by a melting point (Tm), which can be determined by differential scanning calorimetry (DSC). For purposes herein, the maximum of the highest temperature peak is considered to be the melting point of the polymer. A “peak” in this context is defined as a change in the general slope of the DSC curve (heat flow versus temperature) from positive to negative, forming a maximum without a shift in the baseline where the DSC curve is plotted so that an endothermic reaction would be shown with a positive peak.

In any embodiment, the Tm of the one or more polymers of the PBP (as determined by DSC) may be less than about 130° C., or less than about 120° C., or less than about 115° C., or less than about 110° C., or less than about 100° C., or less than about 90° C. In any embodiment, the Tm of the one or more polymers of the PBP may be greater than about 25° C., or greater than about 30° C., or greater than about 35° C., or greater than about 40° C. Tm of the one or more polymers of the PBP can be determined by taking 5 to 10 mg of a sample of the one or more polymers, equilibrating a DSC Standard Cell FC at −90° C., ramping the temperature at a rate of 10° C. per minute up to 200° C., maintaining the temperature for 5 minutes, lowering the temperature at a rate of 10° C. per minute to −90° C., ramping the temperature at a rate of 10° C. per minute up to 200° C., maintaining the temperature for 5 minutes, and recording the temperature as Tm.

In one or more embodiments, the crystallization temperature (Tc) of the one or more polymers of the PBP (as determined by DSC) is less than about 100° C., or less than about 90° C., or less than about 80° C., or less than about 70° C., or less than about 60° C., or less than about 50° C., or less than about 40° C., or less than about 30° C., or less than about 20° C., or less than about 10° C. In the same or other embodiments, the Tc of the polymer is greater than about 0° C., or greater than about 5° C., or greater than about 10° C., or greater than about 15° C., or greater than about 20° C. In any embodiment, the Tc lower limit of the polymer may be 0° C., 5° C., 10° C., 20° C., 30° C., 40° C., 50° C., 60° C., and 70° C.; and the Tc upper limit temperature may be 120° C., 110° C., 100° C., 90° C., 80° C., 70° C., 60° C., 50° C., 40° C., 30° C., 25° C., and 20° C. with ranges from any lower limit to any upper limit being contemplated. Tc of the polymer blend can be determined by taking 5 to 10 mg of a sample of the polymer blend, equilibrating a DSC Standard Cell FC at −90° C., ramping the temperature at a rate of 10° C. per minute up to 200° C., maintaining the temperature for 5 minutes, lowering the temperature at a rate of 10° C. per minute to −90° C., and recording the temperature as Tc.

The polymers suitable for use in the PBP are said to be “semi-crystalline,” meaning that in general they have a relatively low crystallinity. The term “crystalline” as used herein broadly characterizes those polymers that possess a high degree of both inter and intra molecular order, and which preferably melt higher than 110° C., more preferably higher than 115° C., and most preferably above 130° C. A polymer possessing a high inter and intra molecular order is said to have a “high” level of crystallinity, while a polymer possessing a low inter and intra molecular order is said to have a “low” level of crystallinity. Crystallinity of a polymer can be expressed quantitatively, e.g., in terms of percent crystallinity, usually with respect to some reference or benchmark crystallinity. As used herein, crystallinity is measured with respect to isotactic polypropylene homopolymer. Preferably, heat of fusion is used to determine crystallinity. Thus, for example, assuming the heat of fusion for a highly crystalline polypropylene homopolymer is 190 J/g, a semi-crystalline propylene copolymer having a heat of fusion of 95 J/g will have a crystallinity of 50%. The term “crystallizable” as used herein refers to those polymers which can crystallize upon stretching or annealing. Thus, in certain specific embodiments, the semi-crystalline polymer may be crystallizable. The semi-crystalline polymers used in specific embodiments of this invention preferably have a crystallinity of from 2% to 65% of the crystallinity of isotatic polypropylene. In further embodiments, the semi-crystalline polymers may have a crystallinity of from about 3% to about 40%, or from about 4% to about 30%, or from about 5% to about 25% of the crystallinity of isotactic polypropylene.

The semi-crystalline polymer of the PBP can have a level of isotacticity expressed as percentage of isotactic triads (three consecutive propylene units), as measured by ¹³C NMR, of 75 mol % or greater, 80 mol % or greater, 85 mol % or greater, 90 mol % or greater, 92 mol % or greater, 95 mol % or greater, or 97 mol % or greater. In one or more embodiments, the triad tacticity may range from about 75 mol % to about 99 mol %, or from about 80 mol % to about 99 mol %, or from about 85 mol % to about 99 mol %, or from about 90 mol % to about 99 mol %, or from about 90 mol % to about 97 mol %, or from about 80 mol % to about 97 mol %. Triad tacticity is determined by the methods described in U.S. Patent Publication No. 2004/0236042.

The semi-crystalline polymer of the PBP may have a tacticity index m/r ranging from a lower limit of 4, or 6 to an upper limit of 10, or 20, or 25. The tacticity index, expressed herein as “m/r”, is determined by ¹³C nuclear magnetic resonance (“NMR”). The tacticity index m/r is calculated as defined by H. N. Cheng in Macromolecules, 17, 1950 (1984), incorporated herein by reference. The designation “m” or “r” describes the stereochemistry of pairs of contiguous propylene groups, “m” referring to meso and “r” to racemic. An m/r ratio of 1.0 generally describes an atactic polymer, and as the m/r ratio approaches zero, the polymer is increasingly more syndiotactic. The polymer is increasingly isotactic as the m/r ratio increases above 1.0 and approaches infinity.

In one or more embodiments, the semi-crystalline polymer of the PBP may have a density of from about 0.85 g/cm³ to about 0.92 g/cm³, or from about 0.86 g/cm³ to about 0.90 g/cm³, or from about 0.86 g/cm³ to about 0.89 g/cm³ at room temperature and determined according to ASTM D-792.

In one or more embodiments, the semi-crystalline polymer of the PBP can have a weight average molecular weight (Mw) of from about 5,000 to about 500,000 g/mol, or from about 7,500 to about 300,000 g/mol, or from about 10,000 to about 200,000 g/mol, or from about 25,000 to about 175,000 g/mol.

Weight-average molecular weight, M_{w}, molecular weight distribution (MWD) or M_{w}/Mₙ (also referred to as polydispersity index) where Mₙ is the number-average molecular weight, and the branching index, g′(vis), are characterized using a High Temperature Size Exclusion Chromatograph (SEC), equipped with a differential refractive index detector (DRI), an online light scattering detector (LS), and a viscometer. Experimental details not shown below, including how the detectors are calibrated, are described in: T. Sun, P. Brant, R. R. Chance, and W. W. Graessley, Macromolecules, Volume 34, Number 19, pp. 6812-6820, 2001. In one or more embodiments, the PBP can have a polydispersity index of from about 1.5 to about 6.

In an embodiment, the PBP has a melt viscosity, measured at 190° C. within the range of from about 800 or 1,000 or 5,000 cP to about 10,000 or 15,000 cP. In an embodiment, the PBP has a Melt Flow Rate (“MFR”, 230° C./2.16 kg) within the range of from about 1,000 or 2,000 g/10 min to about 5,000 or 10,000 g/10 min.

Solvent for the SEC experiment is prepared by dissolving 6 g of butylated hydroxy toluene as an antioxidant in 4 L of Aldrich reagent grade 1,2,4trichlorobenzene (TCB). The TCB mixture is then filtered through a 0.7 μm glass pre-filter and subsequently through a 0.1 μm Teflon filter. The TCB is then degassed with an online degasser before entering the SEC. Polymer solutions are prepared by placing the dry polymer in a glass container, adding the desired amount of TCB, then heating the mixture at 160° C. with continuous agitation for about 2 hr. All quantities are measured gravimetrically. The TCB densities used to express the polymer concentration in mass/volume units are 1.463 g/mL at room temperature and 1.324 g/mL at 135° C. The injection concentration ranges from 1.0 to 2.0 mg/mL, with lower concentrations being used for higher molecular weight samples. Prior to running each sample the DRI detector and the injector are purged. Flow rate in the apparatus is then increased to 0.5 mL/min, and the DRI was allowed to stabilize for 8-9 hr before injecting the first sample. The LS laser is turned on 1 to 1.5 hr before running samples.

The concentration, c, at each point in the chromatogram is calculated from the baseline-subtracted DRI signal, I_{DRI}, using the following equation:

c=K_{DRI}I_{DRI}/(dn/dc)

where K_{DRI} is a constant determined by calibrating the DRI, and dn/dc is the same as described below for the LS analysis. Units on parameters throughout this description of the SEC method are such that concentration is expressed in g/cm³, molecular weight is expressed in kg/mol, and intrinsic viscosity is expressed in dL/g.

The light scattering detector used is a Wyatt Technology High Temperature mini-DAWN. The polymer molecular weight, M, at each point in the chromatogram is determined by analyzing the LS output using the Zimm model for static light scattering (M. B. Huglin, Light Scattering from Polymer Solutions, Academic Press, 1971):

[Kₒc/ΔR(θ,c)]=[1/MP(θ)]+2A₂c

where ΔR(θ) is the measured excess Rayleigh scattering intensity at scattering angle θ, c is the polymer concentration determined from the DRI analysis, A₂ is the second virial coefficient, P(θ) is the form factor for a monodisperse random coil (described in the above reference), and Kₒ is the optical constant for the system:

$${K}_{o} = \frac{4 {π}^{2} {{n}^{2} ( dn \text{/} d c )}^{2}}{{λ}^{4} {N}_{A}}$$

in which N_{A} is the Avogadro's number, and dn/dc is the refractive index increment for the system. The refractive index, n=1.500 for TCB at 135° C. and λ=690 nm. In addition, A₂=0.0015 and dn/dc=0.104 for ethylene polymers, whereas A₂=0.0006 and dn/dc=0.104 for propylene polymers.

The molecular weight averages are usually defined by considering the discontinuous nature of the distribution in which the macromolecules exist in discrete fractions i containing Nᵢ molecules of molecular weight Mᵢ. The weight-average molecular weight, M_{w}, is defined as the sum of the products of the molecular weight Mᵢ of each fraction multiplied by its weight fraction wᵢ:

M_{w}≡ΣwᵢMᵢ=(ΣNᵢMᵢ²/ΣNᵢMᵢ)

since the weight fraction wᵢ is defined as the weight of molecules of molecular weight Mᵢ divided by the total weight of all the molecules present:

wᵢ=NᵢMᵢ/ΣNᵢMᵢ

The number-average molecular weight, Mₙ, is defined as the sum of the products of the molecular weight Mᵢ of each fraction multiplied by its mole fraction xᵢ:

Mₙ≡ΣxᵢMᵢ=ΣNᵢMᵢ/ΣNᵢ

since the mole fraction xᵢ is defined as Nᵢ divided by the total number of molecules

xᵢ=Nᵢ/ΣNᵢ

In the SEC, a high temperature Viscotek Corporation viscometer is used, which has four capillaries arranged in a Wheatstone Bridge configuration with two pressure transducers. One transducer measures the total pressure drop across the detector, and the other, positioned between the two sides of the bridge, measures a differential pressure. The specific viscosity, ηₛ, for the solution flowing through the viscometer is calculated from their outputs. The intrinsic viscosity, [η], at each point in the chromatogram is calculated from the following equation:

ηₛ=c[η]+0.3(c[η])²

where c was determined from the DRI output.

The branching index (g′, also referred to as g′(vis)) is calculated using the output of the SEC-DRI-LS-VIS method as follows. The average intrinsic viscosity, [η]_{avg}, of the sample is calculated by:

$${[ η ]}_{avg} = \frac{Σ {{c}_{i} [ η ]}_{i}}{Σ {c}_{i}}$$

where the summations are over the chromatographic slices, i, between the integration limits.

The branching index g′ is defined as:

$${g}^{′} = \frac{{[ η ]}_{avg}}{{kM}_{v}^{α}}$$

where k=0.000579 and α=0.695 for ethylene polymers; k=0.0002288 and α=0.705 for propylene polymers; and k=0.00018 and α=0.7 for butene polymers.

Mᵥ is the viscosity-average molecular weight based on molecular weights determined by the LS analysis:

Mᵥ≡(ΣcᵢMᵢ^{α}/Σcᵢ)^{1/α}

In one or more embodiments, the semi-crystalline polymer of the PBP may have a viscosity (also referred to a Brookfield viscosity or melt viscosity), measured at 190° C. and determined according to ASTM D-3236 from about 100 cP to about 500,000 cP, or from about 100 to about 100,000 cP, or from about 100 to about 50,000 cP, or from about 100 to about 25,000 cP, or from about 100 to about 15,000 cP, or from about 100 to about 10,000 cP, or from about 100 to about 5,000 cP, or from about 500 to about 15,000 cP, or from about 500 to about 10,000 cP, or from about 500 to about 5,000 cP, or from about 1,000 to about 10,000 cP, wherein 1 cP=1 mPa.sec.

The polymers that may be used in the adhesive compositions disclosed herein generally include any of the polymers formed as disclosed in International Publication No. 2013/134038. The triad tacticity and tacticity index of a polymer may be controlled by the catalyst, which influences the stereoregularity of propylene placement, the polymerization temperature, according to which stereoregularity can be reduced by increasing the temperature, and by the type and amount of a comonomer, which tends to reduce the length of crystalline propylene derived sequences.

Polymers and blended polymer products are also provided. In any embodiment, one or more of the polymers described herein may be blended with another polymer, such as another polymer described herein, to produce a physical blend of polymers.

### Catalysts/Activators for Preparing PBPs

In any embodiment, the catalyst systems used for producing semi-crystalline polymers of the PBP may comprise a metallocene compound. In any embodiment, the metallocene compound may be a bridged bisindenyl metallocene having the general formula (In¹)Y(In²)MX₂, where In¹ and In² are identical substituted or unsubstituted indenyl groups bound to M and bridged by Y, Y is a bridging group in which the number of atoms in the direct chain connecting In¹ with In² is from 1 to 8 and the direct chain comprises C, Si, or Ge; M is a Group 3, 4, 5, or 6 transition metal; and X₂ are leaving groups. In¹ and In² may be substituted or unsubstituted. If In¹ and In² are substituted by one or more substituents, the substituents are selected from the group consisting of a halogen atom, C₁ to C₁₀ alkyl, C₅ to C₁₅ aryl, C₆ to C₂₅ alkylaryl, and Si-, N- or P- containing alkyl or aryl. Each leaving group X may be an alkyl, preferably methyl, or a halide ion, preferably chloride or fluoride. Exemplary metallocene compounds of this type include, but are not limited to, μ-dimethylsilylbis(indenyl)hafnium dimethyl and μ-dimethylsilylbis(indenyl)zirconium dimethyl.

In any embodiment, the metallocene compound may be a bridged bisindenyl metallocene having the general formula (In¹)Y(In²)MX₂, where In¹ and In² are identical 2,4-substituted indenyl groups bound to M and bridged by Y, Y is a bridging group in which the number of atoms in the direct chain connecting In¹ with In² is from 1 to 8 and the direct chain comprises C, Si, or Ge, M is a Group 3, 4, 5, or 6 transition metal, and X₂ are leaving groups. In¹ and In² are substituted in the 2 position by a C₁ to C₁₀ alkyl, preferably a methyl group and in the 4 position by a substituent selected from the group consisting of C₅ to C₁₅ aryl, C₆ to C₂₅ alkylaryl, and Si-, N- or P- containing alkyl or aryl. Each leaving group X may be an alkyl, preferably methyl, or a halide ion, preferably chloride or fluoride. Exemplary metallocene compounds of this type include, but are not limited to, (dimethylsilyl)bis(2-methyl-4-(3,′5′-di-tert-butylphenyl)indenyl)zirconium dimethyl, (dimethylsilyl)bis(2-methyl-4-(3,′5′-di-tert-butylphenyl)indenyl)hafnium dimethyl, (dimethylsilyl)bis(2-methyl-4-naphthylindenyl)zirconium dimethyl, (dimethylsilyl)bis(2-methyl-4-naphthylindenyl)hafnium dimethyl, (dimethylsilyl)bis(2-methyl-4-(N-carbazyl)indenyl)zirconium dimethyl, and (dimethylsilyl)bis(2-methyl-4-(N-carbazyl)indenyl)hafnium dimethyl.

Alternatively, in any embodiment, the metallocene compound may correspond to one or more of the formulas disclosed in U.S. Pat. No. 7,601,666. Such metallocene compounds include, but are not limited to, dimethylsilyl bis(2-(methyl)-5,5,8,8-tetramethyl-5,6,7,8-tetrahydrobenz(f)indenyl)hafnium dimethyl, diphenylsilyl bis(2-(methyl)-5,5,8,8-tetramethyl-5,6,7,8-tetrahydrobenz(f)indenyl)hafnium dimethyl, diphenylsilyl bis(5,5,8,8-tetramethyl-5,6,7,8-tetrahydrobenz(f)indenyl)hafnium dimethyl, diphenylsilyl bis(2-(methyl)-5,5,8,8-tetramethyl-5,6,7,8-tetrahydrobenz(f)indenyl)zirconium dichloride, and cyclo-propylsilyl bis(2-(methyl)-5,5,8,8-tetramethyl-5,6,7,8-tetrahydrobenz(f)indenyl)hafnium dimethyl.

In any embodiment, the activators of the catalyst systems used to produce semi-crystalline polymers of the PBP may comprise a cationic component. In any embodiment, the cationic component may have the formula [R¹R²R³AH]⁺, where A is nitrogen, R¹ and R² are together a —(CH₂)ₐ— group, where a is 3, 4, 5, or 6 and form, together with the nitrogen atom, a 4-, 5-, 6-, or 7-membered non-aromatic ring to which, via adjacent ring carbon atoms, optionally one or more aromatic or heteroaromatic rings may be fused, and R³ is C₁, C₂, C₃, C₄, or C₅ alkyl, or N-methylpyrrolidinium or N-methylpiperidinium. Alternatively, in any embodiment, the cationic component has the formula [RₙAH₄₋ₙ]⁺, where A is nitrogen, n is 2 or 3, and all R are identical and are C₁ to C₃ alkyl groups, such as for example trimethylammonium, trimethylanilinium, triethylammonium, dimethylanilinium, or dimethylammonium.

A particularly advantageous catalyst that may be employed in any embodiment is illustrated in Formula I.

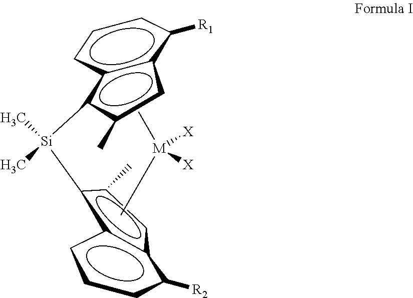

In any embodiment, M is a Group IV transition metal atom, preferably a Group IVB transition metal, more preferably hafnium or zirconium, and X are each an alkyl, preferably methyl, or a halide ion, preferably chloride or fluoride. Methyl or chloride leaving groups are most preferred. In any embodiment, R₁ and R₂ may be independently selected from the group consisting of hydrogen, phenyl, and naphthyl. R₁ is preferably the same as R₂. Particularly advantageous species of Formula I are dimethylsilyl bis(2-methyl-4-phenylindenyl)zirconium dichloride, dimethylsilyl bis(2-methyl-4-phenylindenyl)zirconium dimethyl, dimethylsilyl bis(2-methyl-4-phenylindenyl)hafnium dichloride, and dimethylsilyl bis(2-methyl-4-phenylindenyl)hafnium dimethyl.

Any catalyst system resulting from any combination of a metallocene compound, a cationic activator component, and an anionic activator component mentioned in this disclosure shall be considered to be explicitly disclosed herein and may be used in accordance with the present invention in the polymerization of one or more olefin monomers. Also, combinations of two different activators can be used with the same or different metallocene(s).

In any embodiment, the activators of the catalyst systems used to produce the semi-crystalline polymers may comprise an anionic component, [Y]⁻. In any embodiment, the anionic component may be a non-coordinating anion (NCA), having the formula [B(R⁴)₄]⁻, where R⁴ is an aryl group or a substituted aryl group, of which the one or more substituents are identical or different and are selected from the group consisting of alkyl, aryl, a halogen atom, halogenated aryl, and haloalkylaryl groups. The substituents may be perhalogenated aryl groups, or perfluorinated aryl groups, including, but not limited to, perfluorophenyl, perfluoronaphthyl and perfluorobiphenyl.

Together, the cationic and anionic components of the catalysts systems described herein form an activator compound. In any embodiment, the activator may be N,N-dimethylanilinium-tetra(perfluorophenyl)borate, N,N-dimethylanilinium-tetra(perfluoronaphthyl)borate, N,N-dimethylanilinium-tetrakis(perfluorobiphenyl)borate, N,N-dimethylanilinium-tetrakis(3,5-bis(trifluoromethyl)phenyl)borate, triphenylcarbenium-tetra(perfluorophenyl)borate, triphenylcarbenium-tetra(perfluoronaphthyl)borate, triphenylcarbenium-tetrakis(perfluorobiphenyl)borate, or triphenylcarbenium-tetrakis(3,5-bis(trifluoromethyl)phenyl)borate.

A non-coordinating anion activator may be employed with the catalyst. A particularly advantageous activator is dimethylaniliniumtetrakis(heptafluoronaphthyl)borate.

Suitable activators for the processes of the present invention also include aluminoxanes (or alumoxanes) and aluminum alkyls. Without being bound by theory, an alumoxane is typically believed to be an oligomeric aluminum compound represented by the general formula (R^{x}—Al—O)ₙ, which is a cyclic compound, or R^{x} (R^{x}—Al—O)ₙAlR^{x}₂, which is a linear compound. Most commonly, alumoxane is believed to be a mixture of the cyclic and linear compounds. In the general alumoxane formula, R^{x} is independently a C₁-C₂₀ alkyl radical, for example, methyl, ethyl, propyl, butyl, pentyl, isomers thereof, and the like, and n is an integer from 1-50. In any embodiment, R^{x} may be methyl and n may be at least 4. Methyl alumoxane (MAO), as well as modified MAO containing some higher alkyl groups to improve solubility, ethyl alumoxane, iso-butyl alumoxane, and the like are useful for the processes disclosed herein.

Further, the catalyst systems suitable for use in the present invention may contain, in addition to the transition metal compound and the activator described above, additional activators (co-activators), and/or scavengers. A co-activator is a compound capable of reacting with the transition metal complex, such that when used in combination with an activator, an active catalyst is formed. Co-activators include alumoxanes and aluminum alkyls.

In any embodiment, scavengers may be used to “clean” the reaction of any poisons that would otherwise react with the catalyst and deactivate it. Typical aluminum or boron alkyl components useful as scavengers are represented by the general formula R^{x}JZ₂ where J is aluminum or boron, R^{x} is a C₁-C₂₀ alkyl radical, for example, methyl, ethyl, propyl, butyl, pentyl, and isomers thereof, and each Z is independently R^{x} or a different univalent anionic ligand such as halogen (Cl, Br, I), alkoxide (OR^{x}), and the like. Exemplary aluminum alkyls include triethylaluminum, diethylaluminum chloride, ethylaluminium dichloride, tri-iso-butylaluminum, tri-n-octylaluminum, tri-n-hexylaluminum, trimethylaluminum, and combinations thereof. Exemplary boron alkyls include triethylboron. Scavenging compounds may also be alumoxanes and modified alumoxanes including methylalumoxane and modified methylalumoxane.

### Solvents for Preparing PBPs

The solvent used in the reaction system of the present invention may be any non-polymeric species capable of being removed from the polymer composition by heating to a temperature below the decomposition temperature of the polymer and/or reducing the pressure of the solvent/polymer mixture. In any embodiment, the solvent may be an aliphatic or aromatic hydrocarbon fluid.

Examples of suitable, preferably inert, hydrocarbon fluids are readily volatile liquid hydrocarbons, which include, for example, hydrocarbons containing from 1 to 30, preferably 3 to 20, carbon atoms. Preferred examples include propane, n-butane, isobutane, mixed butanes, n-pentane, isopentane, neopentane, n-hexane, cyclohexane, isohexane, octane, other saturated C₆ to C₈ hydrocarbons, toluene, benzene, ethylbenzene, chlorobenzene, xylene, desulphurized light virgin naphtha, and any other hydrocarbon solvent recognized by those skilled in the art to be suitable for the purposes of this invention. Particularly preferred solvents for use in the processes disclosed herein are n-hexane and toluene.

The optimal amount of solvent present in combination with the polymer at the inlet to the devolatilizer will generally be dependent upon the desired temperature change of the polymer melt within the devolatilizer, and can be readily determined by persons of skill in the art. For example, the polymer composition may comprise, at the inlet of the devolatilizer, from about 1 wt % to about 50 wt % solvent, or from about 5 wt % to about 45 wt % solvent, or from about 10 wt % to about 40 wt % solvent, or from about 10 wt % to about 35 wt % solvent.

International Publication No. 2013/134038 generally describes the catalysts, activators, and solvents used to prepare the polymer blend used in the adhesive compositions. The contents of International Publication No. 2013/134038 and its parent application U.S. Patent Application Ser. No. 61/609,020 filed Mar. 9, 2012, are both incorporated herein in their entirety.

### Optional Process Oil Component

In one or more embodiments of the present invention, one or more process oils may be added to the pressure-sensitive hot melt adhesive compositions described herein. As used herein, the term “process oil” means both petroleum derived process oils and synthetic plasticizers.

Examples of process oils suitable for use in the present invention include, but are not limited to, paraffinic or naphthenic oils such as Primol 352, Sentinel PO 876, and Nyflex 222B.

Further process oils suitable for use in the present invention include aliphatic naphthenic oils, white oils, and the like. Exemplary plasticizers and/or adjuvants include mineral oils, polybutenes, phthalates and the like. In one or more embodiments, the plasticizers may include phthalates such as diisoundecyl phthalate (DIUP), diisononylphthalate (DINP), dioctylphthalates (DOP), and polybutenes, such as Parapol 950 and Parapol 1300 available from ExxonMobil Chemical Company in Houston, Tex. Further useful plasticizers include those described in WO 01/18109A1 and U.S. Publication No. 2004/0106723, which are incorporated by reference herein.

In one or more embodiments, the pressure-sensitive hot melt adhesive compositions described herein may comprise from about 1 to about 50 wt %, or from about 5 to about 40 wt %, or from about 10 to about 35 wt %, or from about 15 to about 30 wt % of the optional process oil component.

### Other Additives and Fillers

In some embodiments, one or more additional fillers or additives may be employed to achieve the properties and characteristics desired in the final adhesive formulation. Such additive and fillers are known in the art and may include, but are not limited to fillers, cavitating agents, antioxidants, surfactants, adjuvants, plasticizers, block, antiblock, colorants, color masterbatches, pigments, dyes, processing aids, UV stabilizers, neutralizers, lubricants, waxes, and/or nucleating agents. The additives may be present in any amount determined to be effective by those skilled in the art, such as for example from about 0.001 wt % to about 10 wt %.

Examples of suitable antioxidants include, but are not limited to, quinolein, e.g., trimethylhydroxyquinolein (TMQ); imidazole, e.g., zincmercapto toluyl imidazole (ZMTI); and conventional antioxidants, such as hindered phenols, lactones, phosphates, and hindered amines. Further suitable anti-oxidants are commercially available from, for example, Ciba Geigy Corp. under the trade names Irgafos 168, Irganox 1010, Irganox 3790, Irganox B225, Irganox 1035, Irgafos 126, Irgastab 410, and Chimassorb 944.

Fillers, cavitating agents and/or nucleating agents suitable for use in the present invention may comprise granular, fibrous, and powder-like materials, and may include, but are not limited to, titanium dioxide, calcium carbonate, barium sulfate, silica, silicon dioxide, carbon black, sand, glass beads, mineral aggregates, talc, natural and synthetic clays, diatomaceous earth, and the like.

Processing aids, lubricants, waxes, and/or oils which may be employed in the adhesive compositions of the present invention include low molecular weight products such as wax, oil, or low Mn polymer, (low meaning having a Mn less than 5000, preferably below 4000, or below 3000, or below 2500). Waxes may include polar or non-polar waxes, functionalized waxes, polypropylene waxes, polyethylene waxes, and wax modifiers.

The additives described herein can be added to the blend in pure form or in master batches.

In one or more embodiments of the present invention, the adhesive compositions described herein may comprise one or more process oils, but are otherwise substantially free of silicon oils or waxes. By “substantially free of” is meant that any silicon oils or waxes in the adhesive composition are present as impurities only; no silicon oils or waxes are added to the adhesive formulation. In an embodiment of the invention, the composition is substantially free of a functional component, wherein the functional component has at least 0.1 wt % of a functional group.

### Preparation of the Pressure-Sensitive Hot Melt Adhesive Composition

In one or more embodiments, the components of the pressure-sensitive hot melt adhesive compositions described herein may be blended by mixing, using any suitable mixing device at a temperature above the melting point of the components, e.g., at 130 to 180° C., for a period of time sufficient to form a homogeneous mixture, normally from about 1 to about 120 minutes depending on the type of mixing device.

In the case of continuous mixing as practiced by most commercial manufacturers, a twin screw extruder may be used to mix the adhesive components. First the block copolymer and propylene-based polymer components are introduced into the extruder and mixed until the polymers have melted and are well mixed. Then the tackifiers are added, followed by any process oils which may be desired. To the extent pigments, antioxidants, fillers, or other additives are used, they are normally blended in with the block copolymer and propylene-based polymer components. The total mixing time is typically on the order of from about 1 to 5 minutes.

In the case of batch mixing, the block copolymer and propylene-based polymer components are added along with 20% of the tackifier component. When the polymers and tackifier reach a homogeneous state, the remaining tackifier component is gradually added to the mix. Once all of the tackifier component has been added and homogeneous mix is achieved, the balance of the process oil, antioxidants, fillers, and any other additives are added. The total mixing time may run for up to 120 minutes.

### Applications

In one or more embodiments of the present invention, adhesive tapes may be formed which comprise a substrate coated with one or more adhesive compositions as described herein. As used herein, the term “tape” is meant generically to encompass any manner of adhesive application, including but not limited to tapes, labels, stickers, decals, packaging applications, and the like.

The adhesive compositions described herein may be applied to any substrate. Suitable substrates may include, but are not limited to, wood, paper, cardboard, plastic, plastic film, thermoplastic, rubber, metal, metal film, metal foil (such as aluminum foil and tin foil), metallized surfaces, cloth, non-wovens (particularly polypropylene spun bonded fibers or non-wovens), spunbonded fibers, cardboard, stone, plaster, glass (including silicon oxide (SiOₓ) coatings applied by evaporating silicon oxide onto a film surface), foam, rock, ceramics, films, polymer foams (such as polyurethane foam), substrates coated with inks, dyes, pigments, PVDC and the like or combinations thereof. Additional substrates may include polyethylene, polypropylene, polyacrylates, acrylics, polyethylene terephthalate, or blends thereof. Corona treatment, electron beam irradiation, gamma irradiation, microwave or silanization may modify any of the above substrates.

The adhesive compositions of this invention may be applied to a substrate as a melt and then cooled. The adhesive composition may be applied to a substrate using conventional coating techniques such as roller coaters, die coaters and blade coaters, generally at a temperature of from about 150° C. to about 200° C. In one or more embodiments, the adhesive composition is applied to a substrate using a slot die.

A slot die is a closed system where an adhesive composition is pumped through the system via a positive displacement pump. The slot die usually includes a rotating bar at the point of the outlet of the adhesive in order to maintain a smooth surface.

The substrate should be coated with sufficient adhesive composition to provide a dry coating weight of from about 10 to about 100, or from about 10 to about 50, or from about 15 to about 25 grams per square meter (gsm).

After coating, the coated substrate is cut to the required dimension. In the manufacture of tape, the substrate is slit into strips and rolled into a finished product. The substrate may also be cut into shaped items to provide labels or medicinal tapers. In one or more embodiments, a release liner may also be employed if desired.

### Properties of the Adhesive Composition

In one or more embodiments, the adhesive compositions of the present invention comprise from about 25 to about 65 wt % of the block copolymer component, from about 5 to about 50 wt % of the hydrocarbon tackifier component, and from about 5 to about 50 wt % of the propylene-based polymer component. In other embodiments, the adhesive compositions of the present invention comprise from about 30 to about 60 wt % of the block copolymer component, from about 10 to about 40 wt % of the hydrocarbon tackifier component, and from about 5 to about 25 wt % of the propylene-based polymer component. In further embodiments, the adhesive compositions of the present invention comprise from about 35 to about 55 wt % of the block copolymer component, from about 15 to about 35 wt % of the hydrocarbon tackifier component, and from about 10 to about 20 wt % of the propylene-based polymer component. In some embodiments, the addition of a process oil to the adhesive composition may be desirable. In such embodiments, the adhesive composition may comprise from about 1 to about 50 wt %, or from about 5 to about 40 wt %, or from about 10 to about 35 wt %, or from about 15 to about 30 wt % of one or more process oils.

In one or more embodiments of the present invention, the adhesive composition has a viscosity greater than about 500 mPa-s, or greater than about 1,000 mPa-s, or greater than about 5,000 mPa-s, or greater than about 10,000 mPa-s (measured at 175° C.). Viscosity may be determined via ASTM D 3236.

In one or more embodiments, the initial 180° peel strength of the adhesive tape compositions described herein when adhered to steel is less than or equal to about 10, or less than or equal to about 8, or less than or equal to about 6, or less than or equal to about 4 N/25 mm (at a coating weight of about 20 gsm). In the same or other embodiments, the initial 180° peel strength of the adhesive tape compositions described herein when adhered to glass is less than or equal to about 10, or less than or equal to about 5, or less than or equal to about 4, or less than or equal to about 3 N/25 mm (at a coating weight of about 20 gsm). In the same or other embodiments, the initial 180° peel strength of the adhesive tape compositions described herein when adhered to polyethylene film is less than or equal to about 10, or less than or equal to about 5, or less than or equal to about 3, or less than or equal to about 2 N/25 mm (at a coating weight of about 20 gsm).

In one or more embodiments, the 180° peel strength of the adhesive tape compositions described herein after one week incubation at 60° C. when adhered to steel is less than or equal to about 35, or less than or equal to about 30, or less than or equal to about 25, or less than or equal to about 20 N/25 mm (at a coating weight of about 20 gsm). In the same or other embodiments, the 180° peel strength of the adhesive tape compositions described herein after one week incubation at 60° C. when adhered to glass is less than or equal to about 30, or less than or equal to about 25, or less than or equal to about 20, or less than or equal to about 15 N/25 mm (at a coating weight of about 20 gsm). In the same or other embodiments, the 180° peel strength of the adhesive tape compositions described herein after one week incubation at 60° C. when adhered to polyethylene film is less than or equal to about 15, or less than or equal to about 10, or less than or equal to about 8, or less than or equal to about 6 N/25 mm (at a coating weight of about 20 gsm).

As used herein, the 180° peel strength of a sample is determined according to FINAT testing method 1 (FTM 1).

Further embodiments of the present invention are described with reference to the following lettered paragraphs:

Paragraph A: A pressure-sensitive hot melt adhesive composition comprising: at least one block copolymer component; at least one hydrocarbon resin tackifier component; and at least one propylene-based polymer component, wherein the propylene-based polymer component comprises a first propylene-based polymer, wherein the first propylene-based polymer is a homopolymer of propylene or a copolymer of propylene and ethylene or a C₄ to C₁₀ alpha-olefin, and a second propylene-based polymer, wherein the second propylene-based polymer is a homopolymer of propylene or a copolymer of propylene and ethylene or a C₄ to C₁₀ alpha-olefin, wherein the second propylene-based polymer is different than the first propylene-based polymer and wherein the propylene-based polymer component has a MFR of greater than about 1,000 g/10 min to less than about 10,000 g/10 min.

Paragraph B: The adhesive of Paragraph A wherein the at least one block copolymer component is a styrenic block copolymer.

Paragraph C: The adhesive composition of Paragraph A and/or B, wherein the propylene-based polymer component has an Mw of about 10,000 g/mol to about 150,000 g/mol.

Paragraph D: The adhesive composition of any one or any combination of Paragraphs B to C, wherein the composition comprises from about 30 to about 60 wt % of the block copolymer component and from about 5 to about 50 wt % of the tackifier component.

Paragraph E: The adhesive composition of any one or any combination of Paragraphs B to D, further comprising at least one process oil component.

Paragraph F: The adhesive composition of any one or any combination of Paragraphs B to E, wherein the at least one block copolymer component is chosen from at least one of a styrene-isoprene block copolymer, styrene-butadiene block copolymer and styrene-isoprene-butadiene block copolymer.

Paragraph G: The adhesive composition of any one or any combination of Paragraphs B to F, wherein the at least one block copolymer component is chosen from at least one of a radial styrene-isoprene block copolymer and a radial styrene-butadiene block copolymer.

Paragraph H: The adhesive composition of any one or any combination of Paragraphs B to G, wherein the at least one block copolymer component is a radial styrene-isoprene block copolymer.

Paragraph I: The adhesive composition of any one or any combination of Paragraphs B to H, wherein the tackifier component has a ring-and-ball softening point of from about 50 to about 140° C.

Paragraph J: The adhesive composition of any one or any combination of Paragraphs B to I, wherein the first propylene-based polymer of the propylene-based polymer component comprises a copolymer of propylene and ethylene, and the second propylene-based polymer of the propylene-based polymer component comprises a copolymer of propylene and ethylene.

Paragraph K: The adhesive composition of any one or any combination of Paragraphs B to J, wherein the propylene-based polymer component has a melt viscosity of about 800 to about 15,000 cP at 190° C.

Paragraph L: The adhesive composition of any one or any combination of Paragraphs B to K, wherein the composition is substantially free of silicon oils and waxes.

Paragraph M: An adhesive composition of any one or any combination of Paragraphs B to L consisting essentially of a styrenic block copolymer component, a tackifier component, a propylene-based polymer component and a process oil component.

Paragraph N: An adhesive article comprising: a substrate; and a pressure-sensitive hot melt adhesive composition comprising: at least one block copolymer component; at least one hydrocarbon resin tackifier component; and at least one propylene-based polymer component, wherein the propylene-based polymer component comprises a first propylene-based polymer, wherein the first propylene-based polymer is a homopolymer of propylene or a copolymer of propylene and ethylene or a C₄ to C₁₀ alpha-olefin, and a second propylene-based polymer, wherein the second propylene-based polymer is a homopolymer of propylene or a copolymer of propylene and ethylene or a C₄ to C₁₀ alpha-olefin, wherein the second propylene-based polymer is different than the first propylene-based polymer and wherein the propylene-based polymer component has a MFR of greater than about 1,000 g/10 min to less than about 10,000 g/10 min.

Paragraph O: The adhesive article of Paragraph N, wherein the at least one block copolymer component is a styrenic block copolymer.

Paragraph P: The adhesive article of Paragraph N and/or O, wherein the propylene-based polymer component has an Mw of about 10,000 g/mol to about 150,000 g/mol.

Paragraph Q: The article of any one or any combination of Paragraphs N to P, wherein the adhesive composition comprises from about 30 to about 60 wt % of the block copolymer component and from about 5 to about 50 wt % of the tackifier component.

Paragraph R: The article of any one or any combination of Paragraphs N to Q, wherein the adhesive composition further comprises at least one process oil component.

Paragraph S: The article of any one or any combination of Paragraphs N to R, wherein the at least one block copolymer component is chosen from at least one of a styrene-isoprene block copolymer, a styrene-butadiene block copolymer, a styrene-isoprene-butadiene block copolymer, a radial styrene-isoprene block copolymer, and a radial styrene-butadiene block copolymer.

Paragraph T: The article of any one or any combination of Paragraphs N to S, wherein the adhesive composition is substantially free of silicon oils and waxes.

Paragraph U: The article of any one or any combination of Paragraphs N to T, wherein the propylene-based polymer component has a melt viscosity of about 800 to about 15,000 cP at 190° C.

Paragraph V: The article of any one or any combination of Paragraphs N to U, wherein the initial 180° peel strength on a steel substrate is lower than or equal to 10 N/25 mm at a coating weight of about 20 gsm.

Paragraph W: The article of any one or any combination of Paragraphs N to V, wherein the initial 180° peel strength on a glass substrate is lower than or equal to 10 N/25 mm at a coating weight of about 20 gsm.

Paragraph X: The article of any one or any combination of Paragraphs N to W, wherein the initial 180° peel strength on a polyethylene film substrate is lower than or equal to 10 N/25 mm at a coating weight of about 20 gsm.

Paragraph Y: The article of any one or any combination of Paragraphs N to X, wherein the shear at 23° C. on a steel substrate (25 mm*25 mm, 1 Kg) is greater than or equal to 10 hours.

### EXAMPLES

The following examples are illustrative of the invention. Materials used in the preparation of the adhesive compositions as identified in the examples are as follows:

“EVANS 17050” is a commercially available adhesive from Evans Adhesive Corporation, Ohio.

“EVANS 17096” is a commercially available adhesive from Evans Adhesive Corporation, Ohio.

“SBC 1” is a styrene-isoprene (SI)ₙ block copolymer having a primarily 4-arm radial structure. SBC 1 has a diblock content of approximately 73 wt %, a styrene content of approximately 18 wt %, a Melt Flow Rate (MFR) (200° C., 5 kg) of about 23 g/10 min, and a specific gravity of about 0.93. SBC 1 is available under the trade name Vector 4186A from Dexco Polymers LP, Houston, Tex.

“SBC 2” is a linear triblock copolymer based on styrene and ethylene/butylene, with a bound styrene of 30 wt %, a Melt Flow Rate (MFR) (230° C., 5 kg) of about 6 g/10 min, and a specific gravity of about 0.91. SBC 2 is available under the trade name Kraton G1652E from Kraton.

“SBC 3” is available under the trade name Kraton G1648 from Kraton.

Vistamaxx™ 6202 is a propylene-ethylene elastomeric copolymer having an ethylene content of approximately 15 wt % and a Melt Flow Rate (MFR) (230° C., 2.16 kg) of approximately 18 g/10 min as determined by ASTM D-1238, available from ExxonMobil Chemical Company, Baytown, Tex.

“PBP 1” is a propylene-ethylene polymer component having an ethylene content of approximately 11.5 wt %, a melt viscosity of approximately 7,175 cP at 190° C., and an estimated Melt Flow Rate (MFR) (230° C., 2.16 kg) of approximately 2,000 g/10 min.

“C-PBP 2” is a comparative propylene-ethylene polymer component having an ethylene content of approximately 13 wt %, a MFR (230° C., 2.16 kg) of approximately 48 g/10 min, and an estimated melt viscosity of approximately 6×10⁶ cP at 190° C.

“HC 1” is a cycloaliphatic hydrocarbon tackifier resin having a ring and ball softening point from about 80 to about 90° C. HC 1 is available under the trade name Escorez 5380 from ExxonMobil Chemical Company, Baytown, Tex.

“HC 2” is cycloaliphatic hydrocarbon tackifier resin having a ring and ball softening point of about 103° C. HC 2 is available under the trade name Escorez 5400 from ExxonMobil Chemical Company, Baytown, Tex.

Wingtack 10 is a C5-based hydrocarbon resin having a ring and ball softening point of about 10° C. and a glass transition temperature of about −31° C., available from Cray Valley.

Primol 352 is a white mineral oil comprising a purified mixture of liquid saturated hydrocarbons having a kinematic viscosity at 100° C. of approximately 8.5 mm2/s (ASTM D-445) and an average molecular weight of approximately 480 (ASTM D-2502). Primol 352 is manufactured by ExxonMobil.

Irganox 1010 is a phenolic antioxidant having a melting point from about 110° C. to about 125° C. and a density (at 20° C.) of about 1.15 g/cm3. Irganox 1010 is available from Ciba Specialty Chemicals, Switzerland.

Pressure-sensitive hot melt adhesive blend compositions were prepared according to the formulations shown in Table 1. Of the blends listed, Blend D represents an adhesive composition according to the invention, while Blends A, B, C, E, and F are comparative. All amounts are reported in weight percent based on the total weight of block copolymer, hydrocarbon tackifier resin, propylene-based polymer, and other components in the adhesive blend.

A series of adhesive labels were prepared by mixing the blend compositions as set forth in Table 1 in a two blade mixer at 145° C. for a period of 70 minutes. The composition may then be heated to a temperature of 175° C. and then pumped through a coating die onto a label paper substrate. The weight of the applied coating layer may range from about 19 to 21 gsm. After coating, the paper may be laminated to a release liner and the resulting adhesive tape may be wound and cut.

TABLE 1

| | Reference 1 | Reference 2 | A | B | C | D | E | F | G | H | I | J | K | L | M |
|---|---|---|---|---|---|---|---|---|---|---|---|---|---|---|---|
| Vistamaxx ™ | EVANS | EVANS | 8 | | 8 | 20 | | | | | | | | | |
| 6202 | 17050 | 17096 | | | | | | | | | | | | | |
| SBC 1 | | | | | | | | | | | 32 | 28.8 | 27.2 | 25.6 | 22.4 |
| SBC 2 | | | | | | | 5 | | | | | | | | |
| SBC 3 | | | | | | | | 5 | 5 | 10 | | | | | |
| PBP1 | | | 37 | 45 | 37 | 25 | 40 | 35 | 35 | 35 | | | | | |
| C-PBP2 | | | | | | | | | | | | 3.2 | 4.8 | 6.4 | 9.6 |
| HC 1 | | | | | 40 | 40 | | | | | | | | | |
| HC 2 | | | 40 | 40 | | | 40 | 40 | 40 | 30 | 49.5 | 49.5 | 49.5 | 49.5 | 49.5 |
| Wingtack 10 | | | | | | | | | 20 | 10 | | | | | |
| Primol 352 | | | 15 | 15 | 15 | 15 | 15 | 20 | | 15 | 18 | 18 | 18 | 18 | 18 |
| Irganox 1010 | | | 0.5 | 0.5 | 0.5 | 0.5 | 0.5 | 0.5 | 0.5 | 0.5 | 0.5 | 0.5 | 0.5 | 0.5 | 0.5 |

It is expected that adhesive compositions according to the invention demonstrate that, when properly tackified, superior shear properties, good removability and excellent wetting of standard substrates can be noted. The data is further expected to show that addition of the propylene-based polymer in the inventive compositions described herein improves internal cohesive strength of the adhesive and thereby reduces the occurrence of cohesive failure or fogging. As the PBP1 used in the present examples is a high melt flow rate polymer, it is appreciated that higher polymer loading of the adhesive formulation as compared to the adhesive formulations disclosed in U.S. Publication No. 2011/0104487, having PE 1(a propylene-ethylene elastomeric copolymer with a MFR of approximately 18 g/10 min).

For purposes of convenience, various specific test procedures are identified above for determining certain properties. However, when a person of ordinary skill reads this patent and wishes to determine whether a composition or polymer has a particular property identified in a claim, then any published or well-recognized method or test procedure can be followed to determine that property, although the specifically identified procedure is preferred. Each claim should be construed to cover the results of any of such procedures, even to the extent different procedures can yield different results or measurements. Thus, a person of ordinary skill in the art is to expect experimental variations in measured properties that are reflected in the claims.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

We claim:

1. A pressure-sensitive hot melt adhesive composition comprising:
a. at least one block copolymer component;
b. at least one hydrocarbon resin tackifier component; and
c. at least one propylene-based polymer component, wherein the propylene-based polymer component comprises a first propylene-based polymer, wherein the first propylene-based polymer is a homopolymer of propylene or a copolymer of propylene and ethylene or a C₄ to C₁₀ alpha-olefin, and a second propylene-based polymer, wherein the second propylene-based polymer is a homopolymer of propylene or a copolymer of propylene and ethylene or a C₄ to C₁₀ alpha-olefin, wherein the second propylene-based polymer is different than the first propylene-based polymer and wherein the propylene-based polymer component has a MFR of greater than about 1,000 g/10 min to less than about 10,000 g/10 min.

2. The adhesive of claim 1, wherein the at least one block copolymer component is a styrenic block copolymer.

3. The adhesive composition of claim 1, wherein the propylene-based polymer component has an Mw of about 10,000 g/mol to about 150,000 g/mol.

4. The adhesive composition of claim 1, wherein the composition comprises from about 30 to about 60 wt % of the block copolymer component and from about 5 to about 50 wt % of the tackifier component.

5. The adhesive composition of claim 1, further comprising at least one process oil component.

6. The adhesive composition of claim 1, wherein the at least one block copolymer component is chosen from at least one of a styrene-isoprene block copolymer, styrene-butadiene block copolymer and styrene-isoprene-butadiene block copolymer.

7. The adhesive composition of claim 1, wherein the at least one block copolymer component is chosen from at least one of a radial styrene-isoprene block copolymer and a radial styrene-butadiene block copolymer.

8. The adhesive composition of claim 1, wherein the at least one block copolymer component is a radial styrene-isoprene block copolymer.

9. The adhesive composition of claim 1, wherein the tackifier component has a ring-and-ball softening point of from about 50 to about 140° C.

10. The adhesive composition of claim 1, wherein the first propylene-based polymer of the propylene-based polymer component comprises a copolymer of propylene and ethylene, and the second propylene-based polymer of the propylene-based polymer component comprises a copolymer of propylene and ethylene.

11. The adhesive composition of claim 1, wherein the propylene-based polymer component has a melt viscosity of about 800 to about 15,000 cP at 190° C.

12. The adhesive composition of claim 1, wherein the composition is substantially free of silicon oils and waxes.

13. An adhesive composition of claim 1, consisting essentially of a styrenic block copolymer component, a tackifier component, a propylene-based polymer component and a process oil component.

14. An adhesive article comprising:
a. a substrate; and
b. a pressure-sensitive hot melt adhesive composition comprising:
i. at least one block copolymer component;
ii. at least one hydrocarbon resin tackifier component; and
iii. at least one propylene-based polymer component, wherein the propylene-based polymer component comprises a first propylene-based polymer, wherein the first propylene-based polymer is a homopolymer of propylene or a copolymer of propylene and ethylene or a C₄ to C₁₀ alpha-olefin, and a second propylene-based polymer, wherein the second propylene-based polymer is a homopolymer of propylene or a copolymer of propylene and ethylene or a C₄ to C₁₀ alpha-olefin, wherein the second propylene-based polymer is different than the first propylene-based polymer and wherein the propylene-based polymer component has a MFR of greater than about 1,000 g/10 min to less than about 10,000 g/10 min.

15. The adhesive article of claim 14, wherein the at least one block copolymer component is a styrenic block copolymer.

16. The adhesive article of claim 14, wherein the propylene-based polymer component has an Mw of about 10,000 g/mol to about 150,000 g/mol.

17. The article of claim 14, wherein the adhesive composition comprises from about 30 to about 60 wt % of the block copolymer component and from about 5 to about 50 wt % of the tackifier component.

18. The article of claim 14, wherein the adhesive composition further comprises at least one process oil component.

19. The article of claim 14, wherein the at least one block copolymer component is chosen from at least one of styrene-isoprene block copolymer, a styrene-butadiene block copolymer, a styrene-isoprene-butadiene block copolymer, a radial styrene-isoprene block copolymer, and a radial styrene-butadiene block copolymer.

20. The article of claim 14, wherein the adhesive composition is substantially free of silicon oils and waxes.

21. The article of claim 14, wherein the propylene-based polymer component has a melt viscosity of about 800 to about 15,000 cP at 190° C.

22. The article of claim 14, wherein the initial 180° peel strength on a steel substrate is lower than or equal to 10 N/25 mm at a coating weight of about 20 gsm.

23. The article of claim 14, wherein the initial 180° peel strength on a glass substrate is lower than or equal to 10 N/25 mm at a coating weight of about 20 gsm.

24. The article of claim 14, wherein the initial 180° peel strength on a polyethylene film substrate is lower than or equal to 10 N/25 mm at a coating weight of about 20 gsm.

25. The article of claim 14, wherein the shear at 23° C. on a steel substrate (25 mm*25 mm, 1 Kg) is greater than or equal to 10 hours.
